(19) United States
(12) Patent Application Publication
(10) Pub. No.: US 2019/0014221 A1
(43) Pub. Date: Jan. 10, 2019

(54) MANAGEMENT SYSTEM AND IMAGE FORMING APPARATUS

(71) Applicant: FUJI XEROX CO., LTD., Tokyo (JP)

(72) Inventor: Minoru YUSA, Kanagawa (JP)

(73) Assignee: FUJI XEROX CO., LTD., Tokyo (JP)

(21) Appl. No.: 16/019,062

(22) Filed: Jun. 26, 2018

(30) Foreign Application Priority Data
Jul. 10, 2017 (JP) 2017-134740

(51) Int. Cl. H04N 1/00

(52) U.S. Cl. CPC H04N 1/0001; H04N 1/00029; H04N 1/00037

(57) ABSTRACT

A management system includes a detecting unit that detects a failure of an information processing apparatus that performs a process in response to reception of data from a management target apparatus, and a controller that controls an amount of data that is transmitted to the management target apparatus in response to the failure detected by the detecting unit.

### CROSS-REFERENCE TO RELATED APPLICATIONS

This application is based on and claims priority under 35 USC 119 from Japanese Patent Application No. 2017-134740 filed Jul. 10, 2017.

### BACKGROUND

### Technical Field

The present invention relates to a management system and an image forming apparatus.

### SUMMARY

According to an aspect of the invention, there is provided a management system. A management system includes a detecting unit that detects a failure of an information processing apparatus that performs a process in response to reception of data from a management target apparatus, and a controller that controls an amount of data that is transmitted to the management target apparatus in response to the failure detected by the detecting unit.

### BRIEF DESCRIPTION OF THE DRAWINGS

Exemplary embodiment of the present invention will be described in detail based on the following figures, wherein:

FIG. 1A and FIG. 1B generally illustrates a management system of an exemplary embodiment, wherein FIG. 1A is a block diagram schematically illustrating the management system, and FIG. 1B is a block diagram schematically illustrating an image forming apparatus;

FIG. 2A through FIG. 2C are block diagrams illustrating devices forming the management system, wherein FIG. 2A is a block diagram illustrating a portal server, FIG. 2B is a block diagram illustrating a transmission level information storage device, and FIG. 2C is a block diagram illustrating a transmission level determination device;

FIG. 3A through FIG. 3C are block diagrams of devices forming the management system, wherein FIG. 3A is a block diagram illustrating a sorting server, FIG. 3B is a block diagram illustrating an application server, and FIG. 3C is a block diagram illustrating a failure related information storage device;

FIG. 4 illustrates an example of association information stored on the failure related information storage device;

FIG. 5 illustrates another example of the association information;

FIG. 6A and FIG. 6B illustrate contents of the failure of FIG. 5, wherein FIG. 6A illustrates the case in which three sorting servers are employed, and FIG. 6B illustrates the case in which four sorting servers are employed;

FIG. 7 is a flowchart illustrating a control process of the management system; and

FIG. 8 is a flowchart illustrating a control process of the management system.

### DETAILED DESCRIPTION

An exemplary embodiment of the invention is described in detail with reference to the drawings.

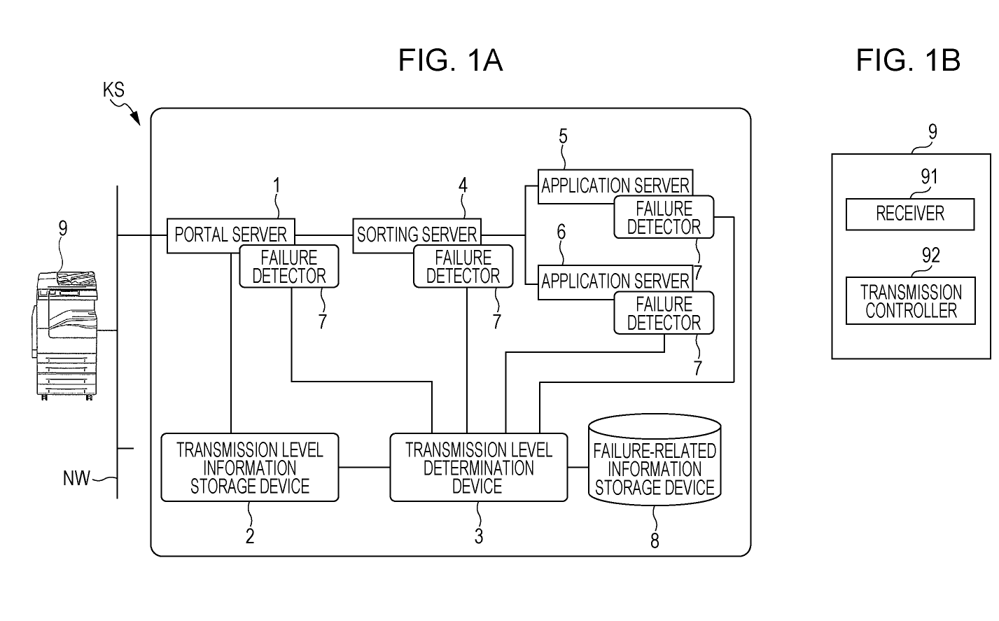

FIG. 1A and FIG. 1B illustrate a configuration of a management system KS of an exemplary embodiment. FIG. 1A generally illustrates the management system KS of the exemplary embodiment, and FIG. 1B is a block diagram schematically illustrating an image forming apparatus 9.

Referring to FIG. 1A, the management system KS includes a portal server 1, a sorting server 4, and application servers 5 and 6, and connects to the image forming apparatus 9 via a network NW. The image forming apparatus 9 is an example of a management target apparatus, and the sorting server 4 and the application servers 5 and 6 are examples of information processing apparatuses.

More in detail, the management system KS manages the image forming apparatus 9 that is uniquely identified by a number pre-assigned thereto. When data (event) transmitted from the image forming apparatus 9 is received by the portal server 1, and is then handed over to the sorting server 4. Depending the data, the sorting server 4 transmits the data to one of the application servers 5 and 6, and one of the application servers 5 and 6 as a transmit destination performs a process on the data.

In response to the data reception from the image forming apparatus 9, the management system KS manages the image forming apparatus 9 by aggregating and processing the data on corresponding application servers 5 and 6. More specifically, if failure information is transmitted from the image forming apparatus 9 that is under a maintenance contract, the corresponding application servers 5 and 6 may instruct a maintenance person to visit the site and to take action. For example, if information related to an expendable article, such as toner, is transmitted from the image forming apparatus 9, the corresponding application servers 5 and 6 may order an expendable article from a delivery center such that the expendable article reaches the site before it is fully consumed. If count information of sheets is transmitted from the image forming apparatus 9 that is under contract in which an amount billed per month is determined depending on a count of consumed sheets, the corresponding application servers 5 and 6 perform a series of office operations, such as making an invoice.

Event transmission from the image forming apparatus 9 may be performed at the occurrence of a failure of the image forming apparatus 9, or at the startup of the image forming apparatus 9, or at a timing once every day, or a predetermined hour of the day or on a predetermined day. More specifically, the event transmission from the image forming apparatus 9 may be predetermined depending on the type of the event.

The portal server 1 in the management system KS is designed to communicate with the image forming apparatus 9 via the network NW, and has a functionality of communication gate with the image forming apparatus 9. The sorting server 4 has a functionality to sort events from the image forming apparatus 9 to the application servers 5 and 6. The application servers 5 and 6 have a functionality of processing the events from the image forming apparatus 9 and a functionality of performing a management operation of the image forming apparatus 9. In accordance with the exemplary embodiment, the application servers 5 and 6 may be identical to each other in functionality and may be simply employed for redundancy purposes.

The management system KS could suffer from a failure and may be unable to provide a management service to the image forming apparatus 9. For example, if the sorting server 4 shuts down, the sorting functionality to the application servers 5 and 6 is temporarily suspended, and the application servers 5 and 6 have difficulty in performing the process thereof. If one or both of the application servers 5 and 6 shut down, the process thereof is not performed.

Under such a circumstance, multiple pieces of data of the image forming apparatus 9 received by the portal server 1 dwell in a large quantity on the portal server 1 or the sorting server 4. When the failure is corrected, the sorting server 4 or the application server 5 is to process a large amount of dwelling data at a time. The process may possibly proceed more slowly, and the management system KS takes time to restore a stable operating state. If failure information is included in the dwelling data, the maintenance person has difficulty in performing a maintenance service to the image forming apparatus 9 that has transmitted the failure information. The quality of the management service may be decreased.

The exemplary embodiment addresses the quality decrease in the management service to the image forming apparatus 9 if a failure occurs in the management system KS.

The failure occurrence may be detected by a failure detector 7 that serves as an example of a detecting unit to be described below. Detection results may be output to the transmission level determination device 3.

The failure occurrence refers to a state that the management system KS has difficulty in providing service. In the state, the application servers 5 and 6 are unable to receive and process an event transmitted from the image forming apparatus 9. The failure refers to the case in which the management system KS suffers from a fault or shuts down when the throughput thereof is exceeded, and includes a hardware failure and a software failure. The failure also includes a fault that occurs in each server forming the management system KS, but does not include a failure occurring over the network NW.

Each of the portal server 1, the sorting server 4, and the application servers 5 and 6 includes the failure detector 7 that detects a failure occurring in each of devices. More specifically, the portal server 1 includes a failure detector 7 that detects a failure if it occurs in the portal server 1 itself. Also, the sorting server 4 includes a failure detector 7 that detects a failure if it occurs in the sorting server 4 itself. Each of the application servers 5 and 6 includes a failure detector 7 that detects a failure if it occurs in each of the application servers 5 and 6.

The failure detector 7 transmits, to the transmission level determination device 3 described below, failure occurrence information that identifies contents and/or location of the detected failure.

The failure occurrence information indicates that a predetermined condition regarding the occurrence of a failure is satisfied, and also indicates a necessity to limit event transmission from the image forming apparatus 9. The failure occurrence information includes information that identifies the location, contents, and degree of the failure that has occurred. The failure occurrence information is thus used to notify the transmission level determination device 3 that a failure has occurred.

Referring to FIG. 1A, the management system KS includes a transmission level information storage device 2, a transmission level determination device 3, and a failure-related information storage device 8. The transmission level information storage device 2 stores data transmission level information transmitted from the transmission level determination device 3 as described below, and transmits to the portal server 1 the data transmission level information in response to a request.

The failure-related information storage device 8 stores association information that indicates association of the location of the failure, the contents of the failure, and a data transmission level. The failure-related information storage device 8 transmits the association information to the transmission level determination device 3 in response to a request.

Upon receiving the failure occurrence information, the transmission level determination device 3 determines a data transmission level in response to the association information from the failure-related information storage device 8. The transmission level determination device 3 transmits to the transmission level information storage device 2 the data transmission level determined and information identifying a transmission condition responsive to the determination results.

The portal server 1, the transmission level information storage device 2, the transmission level determination device 3, and the failure-related information storage device 8 are examples of a controller.

When the portal server 1 returns a response to an event received from the image forming apparatus 9, the portal server 1 requests the data transmission level information stored by the transmission level information storage device 2. When the data transmission level information is returned, the portal server 1 loads the data transmission level information on the response and then transmits the resulting response to the image forming apparatus 9.

The data transmission level information identifies the data transmission level that specifies data transmission control of the image forming apparatus 9 in response to the degree of the failure having occurred in the portal server 1 (the location and contents of the failure). The data transmission level information is thus used to modify the transmission condition to a predetermined condition later. In one manner, the data transmission level information includes information that specifies the transmission condition, and the image forming apparatus 9 may identify the transmission condition by simply referencing that information. In the other manner, the transmission condition may be identified by referencing the data transmission level information and other information. In the other manner, information may be commonly shared in advance by the portal server 1 and the image forming apparatus 9, and the transmission condition is identified by using that information together with the data transmission level information from the portal server 1. In accordance with the exemplary embodiment, the other manner is used.

Elements determining the transmission condition may include the location and contents of the failure in the side of the portal server 1 and the type of an event.

The data transmission level information defines the transmission condition of transmission from the image forming apparatus 9 to the portal server 1 and an amount of data transmitted by the image forming apparatus 9 is thus restricted by the transmission condition. More specifically, the data transmission level information specifies the condition of the transmission data of the image forming apparatus 9. For example, the data transmission level information identifies an instruction to instruct the image forming apparatus 9 to process data and transmit the processed data and an instruction to instruct the image forming apparatus 9 to determine a transmission timing.

The data processing includes compression of the data or partial deletion of the data. The data compression is intended to increase a data compression ratio at which a data size of the data is reduced without changing the contents of the data (an amount of information). Multiple events may thus be transmitted at a single transmission operation. The partial deletion of the data is to decimate the data to reduce the amount of data. The amount of information is thus reduced to permit the larger number of events to be transmitted. The decimation rule may be predetermined depending on the type of events.

The data transmission level information may be updated in view of the status of the failure detected by the portal server 1 (for example, an occurrence or correction of the failure). The updated data transmission level information may be transmitted to the image forming apparatus 9.

The transmission condition identified by the data transmission level information is affected by the type of data. The type of data may be determined by considering the degree of urgency and the degree of importance. More specifically, even if a failure occurs in the portal server 1, the data is categorized in advance to provide an available service. For example, a first type of data remains undeleted and is to be definitely transmitted at a desirably unmodified transmission timing. A second type of data remains undeleted but may be transmitted at a later timing. A third type of data may be permitted to be transmitted with part thereof missing, but desirably at an unmodified timing. A fourth type of data may be permitted to be transmitted with part thereof missing at a later timing.

The data transmission level information is an example of the information related to control of the data transmission, and an example of a condition of the data to be transmitted. The response is an example of a reply to the data reception.

The association information is described below.

The portal server 1, the transmission level information storage device 2, the transmission level determination device 3, the sorting server 4, the application servers 5 and 6, and the failure-related information storage device 8 perform information processing in response to information from the image forming apparatus 9, and outputs process results. These devices may include a central processing (CPU) that performs an arithmetic operation using software, a random access memory (RAM), a read only memory (ROM), a display, an input device that inputs signals to a computer system. The portal server 1, the sorting server 4, and the application servers 5 and 6 may be implemented by a personal computer, a workstation, or other computer.

The image forming apparatus 9 prints an image on a medium, and outputs a printed document. The image forming apparatus 9 is a multi-function apparatus that has basic functionalities including a printing functionality, a copying functionality, a scanning functionality, and a communication functionality.

The image forming apparatus 9 may be an electrophotographic system or other system.

Referring to FIG. 1B, the image forming apparatus 9 includes a receiver 91, and a transmission controller 92.

The receiver 91 receives the data transmission level information (an example of the transmission condition of data) from the portal server 1. The transmission controller 92 controls transmission of data to the portal server 1 in response to the data transmission level information received by the receiver 91. The transmission controller 92 in the image forming apparatus 9, when transmitting data, controls the transmission such that an amount of transmission data is reduced through data compression or similar technique. The transmission controller 92 also controls the transmission to reduce the transmission data by modifying the transmission condition or by excluding data as a transmission target, in response to the type of the data (event).

The transmission control may be applied to the information that fails to satisfy the transmission condition of the data transmission level information such that the transmission condition is modified or the information is excluded as a transmission target depending on the type of the information.

Function blocks of the portal server 1, the transmission level information storage device 2, the transmission level determination device 3, the sorting server 4, and the application servers 5 and 6 are described below.

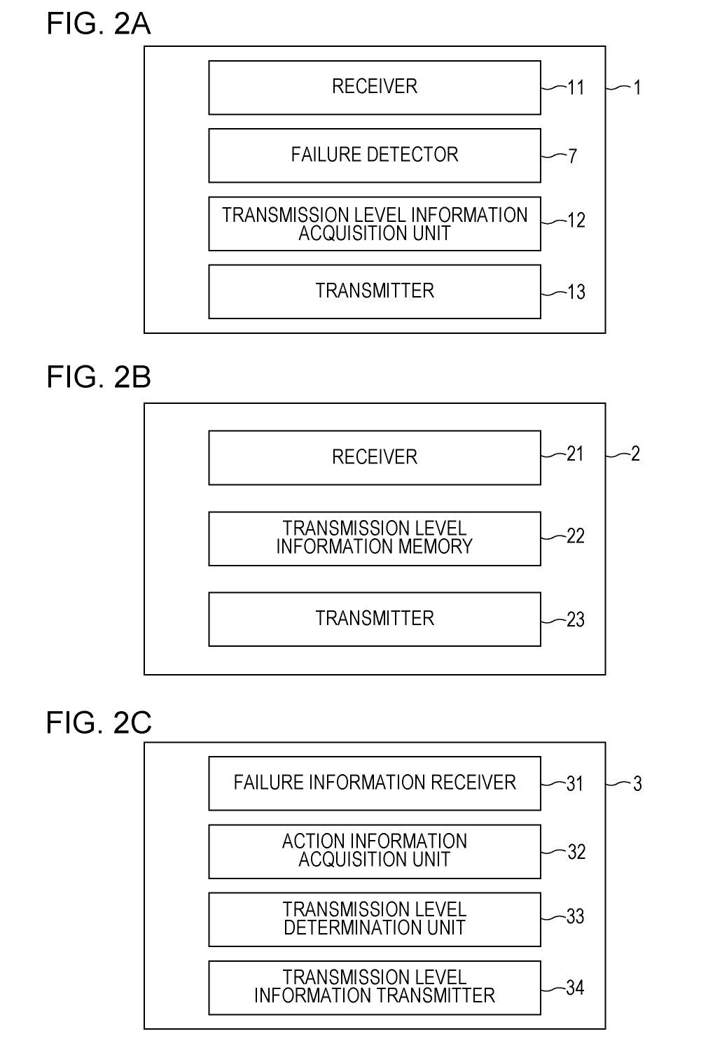

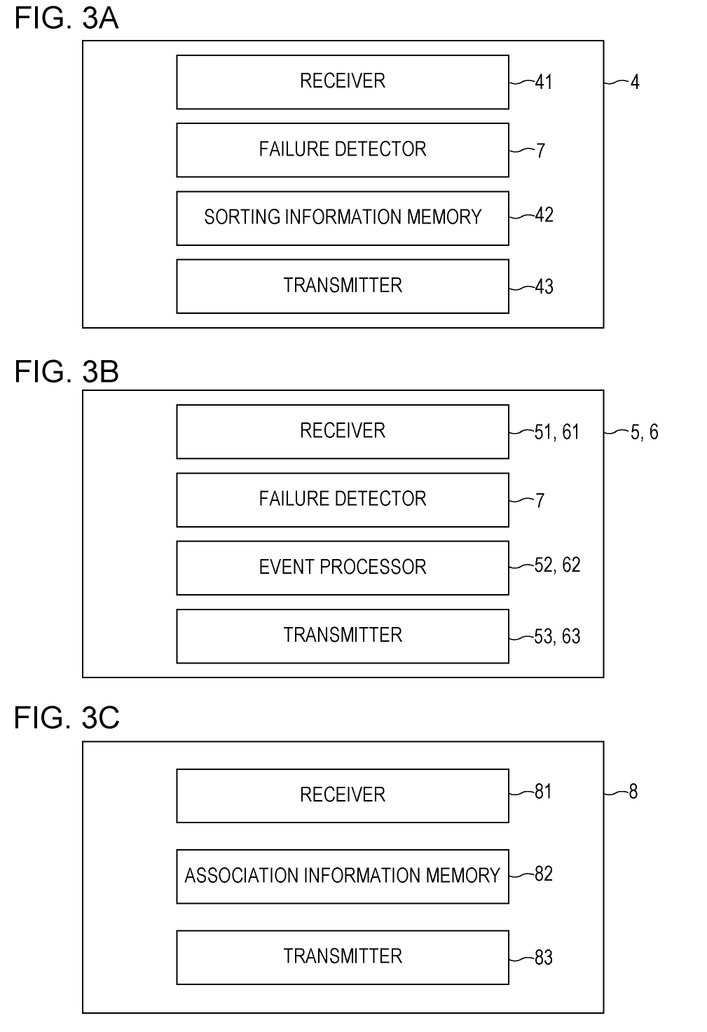

FIG. 2A through FIG. 2C, and FIG. 3A through FIG. 3A are block diagrams of devices forming the management system KS. FIG. 2A is a block diagram illustrating the portal server 1, FIG. 2B is a block diagram illustrating the transmission level information storage device 2, and FIG. 2C is a block diagram illustrating the transmission level determination device 3. FIG. 3A is a block diagram illustrating the sorting server 4, FIG. 3B is a block diagram illustrating the application servers 5 and 6, and FIG. 3C is a block diagram illustrating the failure-related information storage device 8.

Referring to FIG. 2A, the portal server 1 in the management system KS includes a receiver 11, a failure detector 7, a transmission level information acquisition unit 12, and a transmitter 13. The receiver 11 receives data via the network NW. The failure detector 7 detects a failure that has occurred in the portal server 1. The transmission level information acquisition unit 12 acquires the data transmission level information from the transmission level information storage device 2. The transmitter 13 transmits data via the network NW.

The basic operation of the portal server 1 is described below.

When the receiver 11 in the portal server 1 receives data from the image forming apparatus 9, the transmitter 13 transmits the data to the sorting server 4. When the failure detector 7 in the portal server 1 detects the occurrence of a failure, the transmitter 13 transmits the failure occurrence information of the failure to the transmission level determination device 3.

The transmission level information acquisition unit 12 in the portal server 1 determines at a specific timing whether the data transmission level information is stored on the transmission level information storage device 2. If the data transmission level information is not stored on the transmission level information storage device 2, the transmitter 13 transmits to the image forming apparatus 9 a response (an example of a reply) responsive to the data reception. If the data transmission level information is stored on the transmission level information storage device 2, the transmission level information acquisition unit 12 acquires the data transmission level information. The transmitter 13 loads the data transmission level information on the response and then transmits the response with the data transmission level information to the image forming apparatus 9.

The detection results of the failure detector 7 may include a failure occurring in a function block having a transfer functionality, in addition to the basic operations described above.

The failure detector 7 may be designed to detect the occurrence of a failure and may also be designed to detect a change in the failure. The change in the failure refers to any change from the start of the failure, and includes an increased degree of failure or a decreased degree of failure.

Detecting a fine change in the failure increases the workload on the management system KS but reduces a decrease in the quality of the management service caused by the occurrence of the failure.

The change in the failure may include a recovery from the failure. More specifically, the failure detector 7 detects not only the occurrence of a failure but also a recovery from the failure (failure correction). If the occurrence of a failure is detected, the failure detector 7 outputs the failure occurrence information. If the failure correction is detected, the failure detector 7 outputs failure correction information. If the failure detector 7 detects a change in the failure, the failure detector 7 may output failure change information. The failure occurrence information, the failure correction information, and the failure change information may be collectively referred to as the failure information. The failure correction information may include the failure change information.

The failure correction information indicates that a predetermined condition related to a recovery from the failure is satisfied, and thus indicates that an event transmission limit from the image forming apparatus 9 may be canceled. The failure correction information thus reports the recovery from the failure.

When the failure detector 7 detects a failure correction after the occurrence of a failure, the transmitter 13 transmits the failure correction information to the transmission level information storage device 2. In such a case, the transmission level information storage device 2 deletes the stored data transmission level information as described below.

If a failure correction is detected, the failure correction information is directly transmitted to the transmission level information storage device 2.

Alternatively, in a way similar to the way the failure occurrence is detected, the failure correction information is transmitted to the transmission level determination device 3 such that the determination results of the transmission level determination device 3 are reflected in the operation of the transmission level information storage device 2.

Referring to FIG. 2B, the transmission level information storage device 2 includes a receiver 21, and a transmission level information memory 22. The receiver 21 receives the data transmission level information from the transmission level determination device 3. The transmission level information memory 22 stores the data transmission level information received by the receiver 21. The transmission level information storage device 2 also includes a transmitter 23. The transmitter 23 transmits the data transmission level information stored on the transmission level information memory 22 to the portal server 1 in response to a request from the portal server 1.

The transmission level information memory 22 stores newly acquired data transmission level information and updates or deletes the stored data transmission level information. More specifically, when the receiver 21 receives the failure correction information, the transmission level information memory 22 deletes the data transmission level information stored thereon.

In one control method, the data transmission level information corresponding to the failure occurrence information is deleted with no data transmission level information stored thereafter. In another control method contemplated, the transmission level information memory 22 stores the data transmission level information corresponding to the failure correction information.

Referring to FIG. 2C, the transmission level determination device 3 includes a failure information receiver 31, and an association information acquisition unit 32. The failure information receiver 31 receives failure information output from the failure detector 7. The association information acquisition unit 32 acquires association information stored on the failure-related information storage device 8.

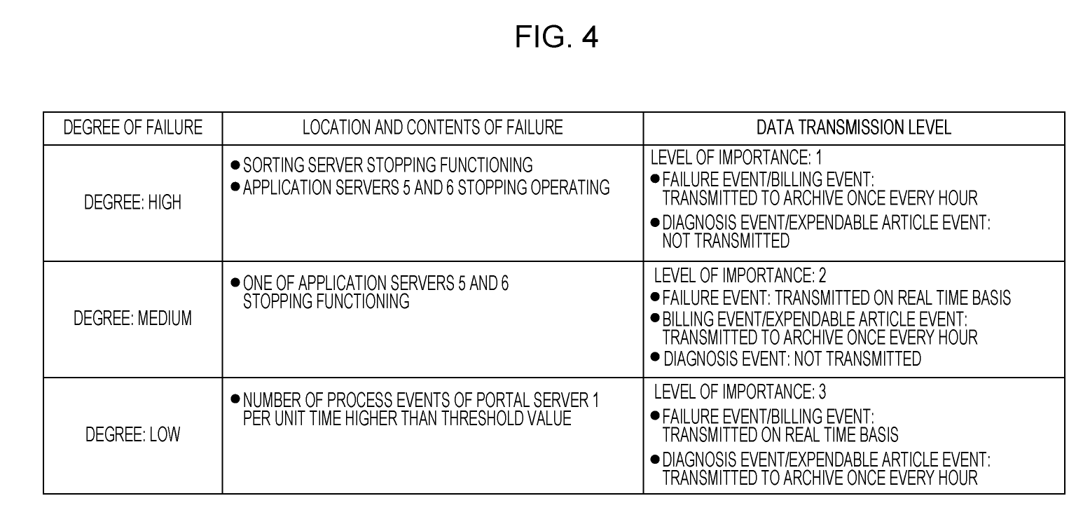

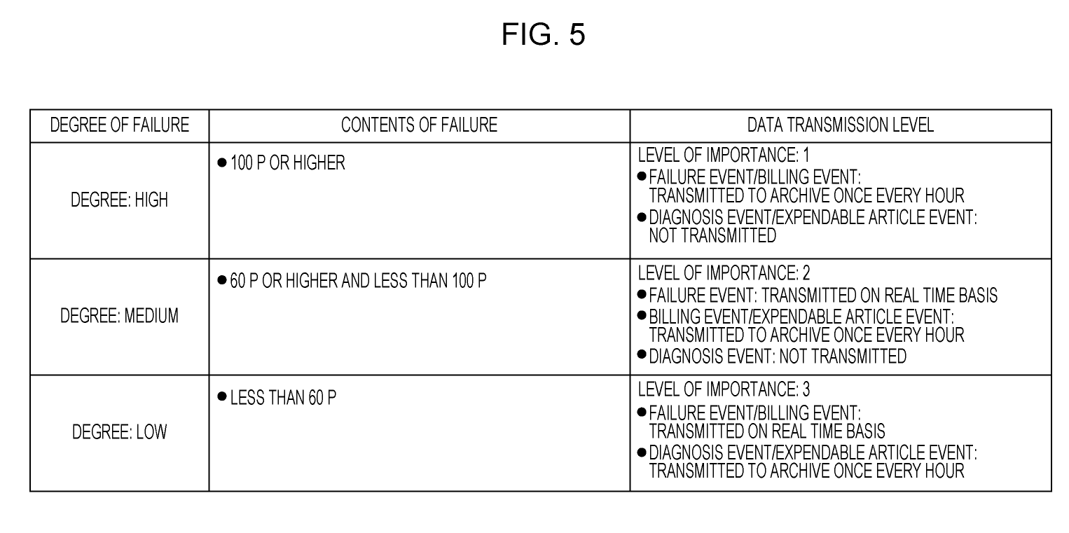

The association information indicates a relationship between a failure occurring in the portal server 1 and the data transmission level, and determines the data transmission level information transmitted to the image forming apparatus 9. The association information is described more below with reference to FIG. 4 and FIG. 5.

The transmission level determination device 3 further includes a transmission level determination unit 33, and a transmission level information transmitter 34. The transmission level determination unit 33 determines the data transmission level, based on the received failure information and the acquired association information, and generates the data transmission level information in response to the determination results. The transmission level information transmitter 34 transmits the data transmission level information generated by the transmission level determination unit 33 to the transmission level information storage device 2.

The failure information receiver 31 in the transmission level determination device 3 receives the failure information detected by the failure detector 7 in the portal server 1. The failure information receiver 31 also receives the failure information detected by the failure detector 7 (see FIG. 1A) in the sorting server 4 and the failure information detected by the failure detector 7 (see FIG. 1A) in each of the application servers 5 and 6. For this reason, the transmission level determination unit 33 performs the determination operation, based on the failure information of the portal server 1, the failure information of the sorting server 4, the failure information of the application servers 5 and 6, or a combination thereof.

As described above, the data transmission level is identified by referencing the association information based on the failure information, and the data transmission level information identifying the data transmission level is transmitted to the image forming apparatus 9.

The configuration of the sorting server 4 is described below.

Referring to FIG. 3A, the sorting server 4 includes a receiver 41, and a failure detector 7. The receiver 41 receives the data of the image forming apparatus 9 transmitted from the portal server 1. The failure detector 7 detects the occurrence of a failure in the sorting server 4. The sorting server 4 further includes a sorting information memory 42 and a transmitter 43. The sorting information memory 42 stores information (sorting information) to identify which of the application servers 5 and 6 the transmitted data is to be sorted to. The transmitter 43 transmits the data to a sorting destination identified by the sorting information, and transmits the detection results of the failure detector 7 to the transmission level determination device 3.

The configuration of the application servers 5 and 6 is described below.

Referring to FIG. 3B, the application servers 5 and 6 respectively include receivers 51 and 56 that receive the data of the image forming apparatus 9 transmitted from the sorting server 4, and event processors 52 and 62 that perform an event process in response to the transmitted data. The application servers 5 and 6 respectively include the failure detectors 7 that detect the occurrence of a failure therewithin, and transmitters 53 and 63 that transmits the detection results of the failure detectors 7 to the transmission level determination device 3.

Referring to FIG. 3C, the failure-related information storage device 8 includes a receiver 81, an association information memory 82, and a transmitter 83. The receiver 81 receives a request of the association information from the transmission level determination device 3. The association information memory 82 stores the association information. The transmitter 83 transmits to the transmission level determination device 3 the association information that the association information memory 82 stores in response to a request from the transmission level determination device 3.

The association information stored on the association information memory 82 may be updated in response to a configuration modification of the management system KS. The updated association information is transmitted to the image forming apparatus 9 via the network NW.

The association information stored on the failure-related information storage device 8 is described below.

FIG. 4 illustrates an example of the association information stored on the failure related information storage device 8.

The association information illustrated in FIG. 4 indicates a relationship between the location where a failure has occurred and the contents of the failure, and the data transmission level in the management system KS. Using the association information, the data transmission level is identified in response to the location of the failure occurrence and the contents of the failure. The identified data transmission level is transmitted as the data transmission level information to the image forming apparatus 9.

The location of the failure occurrence may be in the portal server 1, the sorting server 4, or the application servers 5 and 6, each including the failure detector 7. The contents of the failure may include a shutdown of the management system KS or an increase in the number of process operations. The data transmission level indicates whether the data is transmitted or not, and what data is transmitted in what way, and includes an instruction related to the transmission responsive to the type of the data. FIG. 4 lists a degree of failure indicating the effect of the failure that has occurred, but this parameter may be omitted.

Referring to FIG. 4, a higher degree of failure may include the failure occurrence in the sorting server 4 and the contents of the failure are that the sorting server 4 stops functioning. Also, the failure occurrence may be in both the application servers 5 and 6 and the contents of the failure are that the application servers 5 and 6 stop functioning. In such a case, the data transmission level is defined depending on the type of data transmitted from the image forming apparatus 9.

The type of data here refers to a type of data that the portal server 1 uses to manage the image forming apparatus 9. The type of data indicates data having a higher priority and data having a priority lower than the higher priority data. The type of data is related to predetermined data that is transmitted to the portal server 1 periodically or non-periodically. The type of data also indicates data that involves quick processing, less quick processing, or intermediate urgency processing therebetween. The data that involves quick processing is a failure event to notify of the occurrence of a failure. The data that involves intermediate urgency processing is a billing event to notify of billing responsive to the number of sheets in use. The data that involves less quick processing may include a diagnosis event to notify of results of a diagnosis performed by the image forming apparatus 9 itself, and an expendable article event to notify of running out of expendable articles, such as toner.

The failure event is an example of a first type of information, and the diagnosis event is an example of a second type of information.

In the example of the association information illustrated in FIG. 4, a level of importance 1 corresponds to when the sorting server 4 stops functioning or the application servers 5 and 6 stop functioning. Tag information of the level of importance 1 is associated with an instruction to transmit the event to an archive at a frequency of once every hour when the type of data is the failure event or the billing event. The tag information of the level of importance 1 is also associated with an instruction not to transmit the event when the type of data is the diagnosis event or the expendable article event. More specifically, the diagnosis event or the expendable article event is transmitted when the failure of the portal server 1 is corrected.

When one of the application servers 5 and 6 stops functioning, the data transmission level is shifted to a level of importance 2 which is lower than the level of importance 1. The level of importance 2 is associated with an instruction to transmit the event immediately subsequent to the failure occurrence (real-time transmission) when the type of data is the failure event. The level of importance 2 is also associated with an instruction to transmit the event to the archive (in compression) at a frequency of once every hour when the type of data is the billing event or the expendable article event. The level of importance 2 is also associated with an instruction not to transmit when the type of data is the diagnosis event.

If the number of process events of the portal server 1 per unit time is higher than a threshold value, the data transmission level is lowered to a level of importance 3 that is lower than the level of importance 2. The level of importance 3 is associated with an instruction to immediately transmit the event (real-time transmission) when the type of data is the failure event or the billing event. Also, the level of importance 3 is associated with an instruction to compress and transmit the event at a frequency of once every hour when the type of data is the diagnosis event or the expendable article event.

Referring to the degree of failure of FIG. 4, the level of importance 1 has the highest effect caused by the occurrence of the failure and thus the highest level of importance. The level of importance 3 has the lowest effect and thus the lowest level of importance. In accordance with the exemplary embodiment, the three levels of importance are set. The present invention is not limited to this. Levels of importance more than three or less than three may be set.

Data transmission control related to the association information is described below.

Upon receiving the failure information from the failure detector 7, the transmission level determination device 3 identifies the location of a failure that has occurred, and the contents of the failure, and selects as the data transmission level information one of the level of importance 1, the level of importance 2, and the level of importance 3. The image forming apparatus 9 acquires and stores the data transmission level information selected by the transmission level determination device 3, and performs control to transmit the data or not to transmit the data by referencing the data transmission level information when the event occurs.

If one of the application servers 5 and 6 is found to stop functioning, for example, the transmission level determination device 3 selects the level of importance 2 in response to the association information. When the level of importance 2 is transmitted as the data transmission level information to the image forming apparatus 9, and the expendable article event occurs in the image forming apparatus 9, the image forming apparatus 9 references the association information and collectively transmits the data to the portal server 1 in a compressed form at a frequency of once every hour instead of immediately transmitting the data. In this configuration that the image forming apparatus 9 transmits the data to the portal server 1, the receiver side may possibly suffer a failure. Depending on the degree of failure, the transmission of the data is restricted, and the image forming apparatus 9 selects the data transmission option depending on the restriction contents.

In this way, the image forming apparatus 9 decreases the frequency of transmission by compressing multiple pieces of data to be transmitted. The portal server 1 acquires the multiple pieces of data at a time by decompressing the compressed data, and then successively processes the data. When the failure is corrected, an amount of data that the portal server 1 processes is reduced and time to restore a stable operating state is reduced.

Another example of the association information stored on the failure-related information storage device 8 is described below.

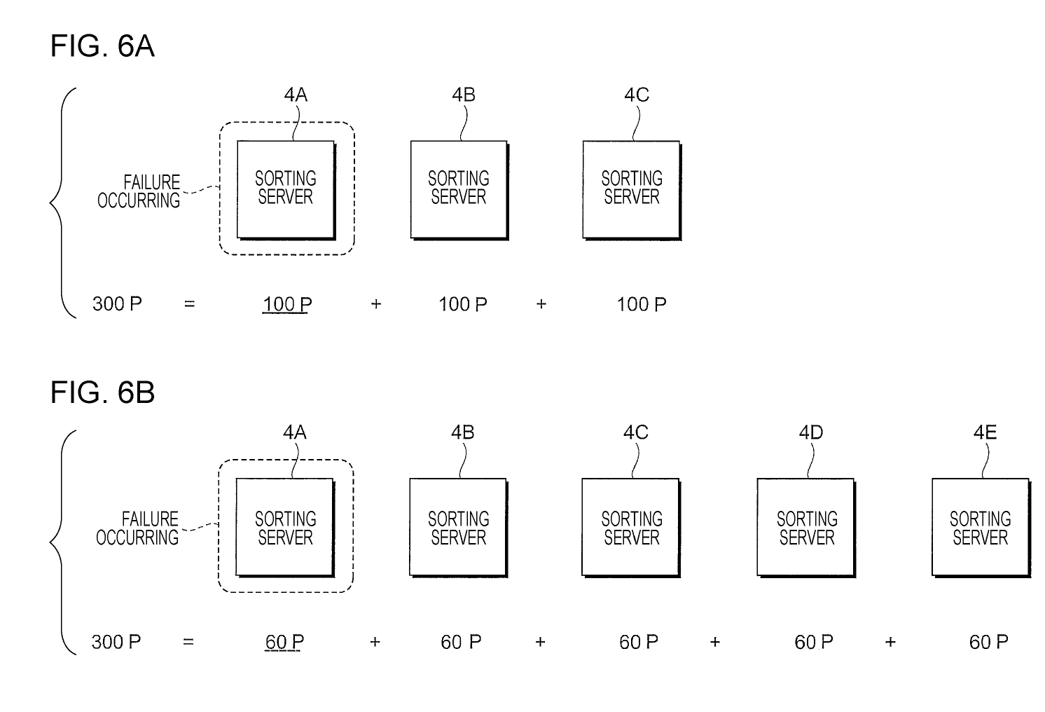

FIG. 5 illustrates another example of the association information. FIG. 6A and FIG. 6B illustrate the contents of failure of FIG. 5. FIG. 6A illustrates three sorting servers 4A, 4B, and 4C. FIG. 6B illustrates three sorting servers 4A, 4B, 4C, 4D, and 4E. The sorting servers 4A, 4B, 4C, 4D, and 4E may also be collectively referred to as the sorting server 4.

FIG. 5A and FIG. 5B correspond to FIG. 4. More specifically, the columns for the degree of failure and the data transmission level are identical to those of FIG. 4. The column for the contents of failure of FIG. 5 corresponds to the column for the location and contents of failure of FIG. 4.

In another example of the association information of FIG. 5, the contents of the failure are defined by a point number (P), and the data transmission level is associated with the point number. A higher point number is associated with the level of importance 1, and a relatively lower point number is associated with the level of importance 2 or the level of importance 3. More specifically, a point number of 100 points (P) or higher is associated with the level of importance 1, a point number equal to 60 P or higher and less than 100 P is associated with the level of importance of 2, and a point number of 60 P or less is associated with the level of importance of 3.

The point number is used to identify the degree of processability responsive to a failure occurring in the portal server 1, and is thus used to determine the degree of effect of the failure on the process performance of the entire management system KS. More specifically, as illustrated in FIG. 6A and FIG. 6B, the point number is assigned to each of the sorting servers 4. The sorting process performance of the entire the management system KS is defined as 300 P. In other words, 300 P are assigned to all the sorting servers 4. Referring to FIG. 6A, each of the sorting servers 4A, 4B, and 4C has a point number 100 P assigned thereto (an example of a first value). If a failure occurs in the sorting server 4A out of the sorting servers 4A, 4B, and 4C, the point number responsive to the failure occurrence is 100 P. The failure is determined to be the level of importance 1 by referencing the association information of FIG. 5.

Referring to FIG. 6B, each of the five sorting servers 4A, 4B, 4C, 4D, and 4E has a point number of 60 P assigned thereto. If a failure occurs in the sorting server 4A out of the sorting servers 4A, 4B, 4C, 4D, and 4E, the point number responsive to the failure occurrence is 60 P. The failure is determined to be the level of importance 2 by referencing the association information of FIG. 5.

If the number of the sorting servers 4 is above five, the point number per server is smaller than 60 P. The point number caused by the failure occurrence in the sorting server 4A is less than 60 P, and the failure is associated with the level of importance 3.

In this way, the transmission of the sorting server 4 is more restricted when the number of the sorting servers 4 is three than when the number of the sorting servers 4 is five.

As described above, in view of the point number assigned to each of the multiple sorting servers 4, a value that is obtained by dividing the point number of the failure occurrence by the number of servers is the point number each sorting server 4 is responsible for. More specifically, the contents of the data transmission control of the image forming apparatus 9 is different depending on a ratio of the number of the sorting servers 4 that have suffered from failures to the number of the sorting servers 4 related to the sorting process. For this reason, if the number of serves is changed, the association between the degree of failure that has occurred and the data transmission level may be automatically modified.

Even if the configuration of the management system KS is modified, the association information stored on the failure-related information storage device 8 may not be necessarily modified. Maintainability is thus improved.

Referring to FIG. 6A and FIG. 6B, the number of all points is equally divided. The present invention is not limited to this method. The point number may be unequally divided depending on the process performance of the sorting servers 4.

Referring to FIG. 6A and FIG. 6B, the number of the sorting servers 4 is changed. The present invention is not limited to this arrangement. The number of the application servers 5 and 6 may be changed. In such a case, the point number may be assigned to each of the application servers 5 and 6 depending on the contents of application programs of the application servers 5 and 6.

The control process of the management system KS is described below.

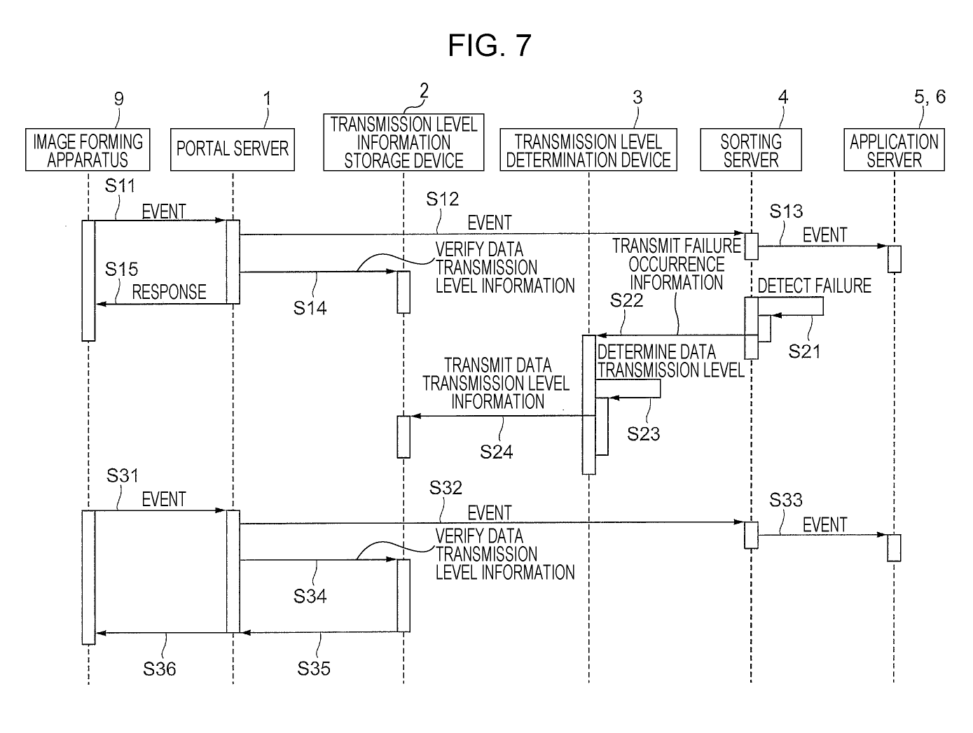

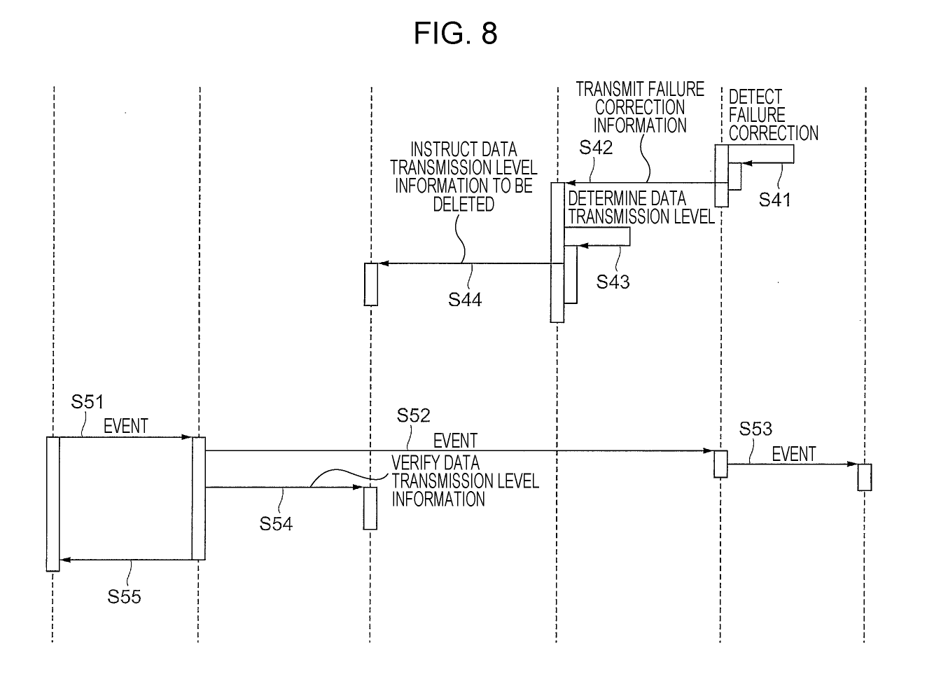

FIG. 7 and FIG. 8 are flowcharts illustrating the control process of the management system KS of the exemplary embodiment.

In the control process of FIG. 7, when the image forming apparatus 9 transmits an event to the portal server 1 (S11), the portal server 1 transmits the event to the sorting server 4 (S12). The sorting server 4 transmits the event to one of the application servers 5 and 6 that is identified by sorting information stored on the sorting server 4 (S13). In this way, the application servers 5 and 6 process the incoming event.

The portal server 1 verifies that the data transmission level information is not stored on the transmission level information storage device 2 (S14) by transmitting an enquiry to the transmission level information storage device 2, and transmits a response to the image forming apparatus 9 in reply to the event (S15).

Upon detecting a failure occurring in the sorting server 4 (S21), the failure detector 7 in the sorting server 4 transmits the failure occurrence information to the transmission level determination device 3 (S22). The transmission level determination device 3 determines the data transmission level, based on the failure occurrence information and the association information (S23), and transmits the data transmission level information to the transmission level information storage device 2 (S24).

In this way, the transmission level information storage device 2 stores the data transmission level information.

When an event transmission timing has come since the storage of the data transmission level information on the transmission level information storage device 2, the image forming apparatus 9 may transmit the event to the portal server 1 (S31). In a similar way as described above, the portal server 1 transmits the event to the sorting server 4 (S32), and the sorting server 4 transmits the event to the application servers 5 and 6 (S33). The portal server 1 verifies whether the data transmission level information is stored on the transmission level information storage device 2 (S34) by transmitting an enquiry to the transmission level information storage device 2 (S34), and acquires the data transmission level information from the transmission level information storage device 2 (S35). The portal server 1 transmits the data transmission level information together with the response thereof to the image forming apparatus 9 (S36). The image forming apparatus 9 thus receives the data transmission level information as an example of the transmission condition of the data. A functionality of receiving the data transmission level information is an example of a functionality of a receiving unit.

Instead of immediately transmitting to the image forming apparatus 9 the data transmission level information at the generation thereof, the portal server 1 waits for an event from the image forming apparatus 9, and then transmits the data transmission level information together with a response responsive to the event. Even if an unauthorized step is taken on the image forming apparatus 9, the image forming apparatus 9 is still able to receive the data transmission level information. Control on the amount of data in response to a failure on the portal server 1 is reliably performed. Alternatively, the transmission to the image forming apparatus 9 may be immediately performed.

As described above, the image forming apparatus 9 performs control to transmit the data responsive to the data transmission level information or not to transmit the data. More specifically, by transmitting only the event responsive to the data transmission level information, the image forming apparatus 9 performs transmission control to restrict the amount of data to be transmitted to the portal server 1. In other words, the portal server 1 notifies the image forming apparatus 9 of a range of action responsive to the occurrence of a failure, and the image forming apparatus 9 performs event transmission control in response to the contents of the notification. In this way, the amount of transmission event from the image forming apparatus 9 is controlled in response to the type of each event. Only an event having a higher degree of priority or a higher degree of urgency is transmitted. The effect of the failure on the management of the image forming apparatus 9 is thus controlled.

The process of FIG. 8 is described. When the failure detector 7 in the sorting server 4 detects a failure correction of the sorting server 4 (S41), the failure detector 7 transmits the failure correction information to the transmission level determination device 3 (S42). The transmission level determination device 3 determines the data transmission level (S43), and instructs the transmission level information storage device 2 to delete the data transmission level information in response to the determination results (S44).

When a next event is transmitted from the image forming apparatus 9 (S51), the portal server 1 transmits the event to the sorting server 4 (S52), the sorting server 4 transmits the event to the application servers 5 and 6 (S53), and the application server 5 verifies the data transmission level information on the transmission level information storage device 2 (S54).

Upon verifying that the data transmission level information is not stored (is updated) on the transmission level information storage device 2, the portal server 1 transmits, to the image forming apparatus 9, information permitting the image forming apparatus 9 to transmit all events, together with the response (S55). The image forming apparatus 9 ends the transmission control to restrict the amount of data to the portal server 1.

If the image forming apparatus 9 receives the data transmission level information together with the response in reply to the event transmission, the network NW is in a normal operation but the portal server 1 may suffer from a failure. The transmission control restricting the amount of data is performed. If the image forming apparatus 9 receives the response but does not receive the data transmission level information, the network NW and the portal server 1 may be in a normal operation state, and the transmission control to restrict the amount data is not performed. If the image forming apparatus 9 receives no response, the network NW may not be in a normal operation state.

In accordance with the exemplary embodiment, if the transmission level determination device 3 stores the data transmission level information of the levels of importance 1 to 3, the amount of data is controlled in response to the degree of failure by restricting the event transmission from the image forming apparatus 9. If the transmission level determination device 3 does not store the data transmission level information, the control operation is performed by not restricting the event transmission. The present invention is not limited to this control operation. For example, as the data transmission level information, a level of importance 4 that does not restrict the event transmission may be set in addition to the levels of importance 1 through 3. More specifically, if a failure correction is detected after the transmission of the data transmission level information of one of the levels of importance 1 through 3 to the image forming apparatus 9, the transmission level information storage device 2 stores the data transmission level information of the level of importance 4, and the portal server 1 transmits the data transmission level information of the level of importance 4 together with the response. In this way, the image forming apparatus 9 performs the normal transmission control based on the fact that the restriction on the event transmission is canceled.

Additionally, when the management system KS is free from performing the control to restrict the amount of data for a failure, the transmission level information storage device 2 may store the data transmission level information of the level of importance 4, and the portal server 1 may transmit the data transmission level information together with the response to the image forming apparatus 9. Although an amount of data is higher when such control is performed than when no such control is performed, the portal server 1 definitely transmits the data transmission level information together with the response. For this reason, the image forming apparatus 9 reliably performs the data transmission control in response to the level of importance determined by the portal server 1.

In accordance with the exemplary embodiment, the application servers 5 and 6 collect as sorting destination destinations the events from the image forming apparatus 9. The present invention is not limited to this arrangement. For example, data may be collected from a device used in Internet of things (IOT) and may be used for failure diagnosis. Devices that may transmit data to the portal server 1 may include a temperature sensor that measure temperature, a humidity sensor that measures humidity, an illuminance sensor that measures illuminance, a human sensor that detects a person indoors (such as an infrared sensor or a monitoring camera).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A management system comprising:
a detecting unit that detects a failure of an information processing apparatus that performs a process in response to reception of data from a management target apparatus; and
a controller that controls an amount of data that is transmitted to the management target apparatus in response to the failure detected by the detecting unit.

2. The management system according to claim 1, wherein the controller assesses the failure of the information processing apparatus detected by the detecting unit in view of a number of the information processing apparatuses, and controls the management target apparatus in response to assessment results.

3. The management system according to claim 2, wherein the controller restricts more transmission of the data to the management target apparatus when the number of the information processing apparatuses is a first value than when the number of the information processing apparatuses is a second value that is higher than the first value.

4. The management system according to claim 2, wherein the controller changes contents of control of the management target apparatus in response to a ratio of the number of the information processing apparatuses suffering from the failure to the number of the information processing apparatuses performing the process.

5. The management system according to claim 1, wherein the controller transmits, to the management target apparatus, information regarding control of transmission of the data together with a response to the reception of the data from the management target apparatus.

6. The management system according to claim 5, wherein the information regarding the control is a condition regarding the data to be transmitted.

7. An image forming apparatus, comprising:
a receiving unit that receives a transmission condition of data from an information processing apparatus; and
a transmitting unit that transmits data to the information processing apparatus such that an amount of the data to be transmitted is decreased in response to the transmission condition of the data received by the receiving unit.

8. The image forming apparatus according to claim 7, wherein the transmission condition of the data of the transmitting unit is different depending whether a type of information is a first type or a second type.

9. A management system comprising:
detecting means that detects a failure of an information processing apparatus that performs a process in response to reception of data from a management target apparatus; and
controller that controls an amount of data that is transmitted to the management target apparatus in response to the failure detected by the detecting means.
